(19) United States
(12) Patent Application Publication
(10) Pub. No.: US 2009/0164061 A1
(43) Pub. Date: Jun. 25, 2009

(54) AUTOMATIC FAN CURVE SELECTION

(76) Inventors: Michael D. VAWTER, Franklin, IN (US); Long-Kung Hwang, Columbus, IN (US)

Correspondence Address: SAWYER LAW GROUP LLP, 2465 E. Bayshore Road, Suite No. 406, PALO ALTO, CA, 94303, US

(21) Appl. No.: 12/185,064

(22) Filed: Aug. 1, 2008

Related U.S. Application Data
(60) Provisional application No. 60/953,464, filed on Aug. 1, 2007.

(51) Int. Cl. G06F 17/00

(52) U.S. Cl. 701/36; 701/54

(57) ABSTRACT

A method and system and method for use in a vehicle. The method includes providing a plurality of fan curves in a vehicle, requesting vehicle information, and selecting a fan curve from the plurality of fan curves based on the vehicle information.

### CROSS REFERENCE TO RELATED APPLICATION

This Application is the U.S. Non-Provisional patent application which claims priority to U.S. Provisional Patent Application No. 60/953,464, filed Aug. 1, 2007, entitled “AUTOMATIC FAN CURVE SELECTION” a portion of which is incorporated herein by this reference.

### RELATED CO-PENDING PATENT APPLICATIONS

The present invention is related to a provisional U.S. application, Application No. 60,953,464, filed on Aug. 1, 2007, and entitled “Automatic Fan Curve Selection,” which is herein incorporated by reference.

### FIELD OF THE INVENTION

The present invention relates to vehicles, and more particularly to a method and system involving fan curve information of a vehicle.

### BACKGROUND OF THE INVENTION

Many transmissions require the engine system of a vehicle to accurately broadcast via a datalink the amount of torque that the engine is creating as well as the amount of torque being consumed by internal and external parasitic losses. The engine system typically estimates the amount of torque being consumed by internal parasitic losses. However, the engine system cannot accurately determine the torque consumed by the largest external parasitic loss, the engine's cooling fan.

Accordingly, what is needed is an improved method and system for processing fan curve information. The present invention addresses such a need.

### SUMMARY OF THE INVENTION

A method and system for use in a vehicle is disclosed. In one embodiment, the method includes providing a plurality of fan curves in a vehicle, requesting vehicle information, and selecting a fan curve from the plurality of fan curves based on the vehicle information. According to the method and system disclosed herein, embodiments of the present invention provide accurate fan torque selection and compensation.

### BRIEF DESCRIPTION OF THE DRAWINGS

FIG. 1 is a block diagram of a vehicle in accordance with one embodiment.

FIG. 2 is a block diagram of a vehicle in accordance with one embodiment.

FIG. 3 is a flow chart showing a method for selecting a fan curve in accordance with one embodiment.

FIG. 4 illustrates an example table showing fan curves for different engines in accordance with one embodiment.

FIG. 5 illustrates an example table showing fan curves for different engines in accordance with another embodiment.

FIG. 6 illustrates a table of information programmed into an engine data plate for a particular engine in accordance with one embodiment.

### DETAILED DESCRIPTION OF THE INVENTION

The present invention relates to vehicles, and more particularly to a method and system involving fan curve information of a vehicle. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiments shown, but is to be accorded the widest scope consistent with the principles and features described herein.

A method and system in accordance with the present invention involving fan curve information are disclosed. The method includes causing the engine electronic control module (ECM) to send a request message to a vehicle cab controller for vehicle information. In one embodiment, the vehicle information includes the vehicle make and model. If a response message is received, the ECM identifies the vehicle information from the response message, and selects a fan curve based on the vehicle information. As a result, embodiments of the present invention provide accurate fan torque selection and compensation. To more particularly describe the features of the present invention, refer now to the following description in conjunction with the accompanying figures.

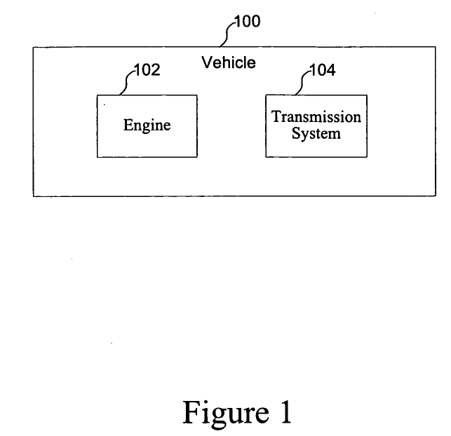

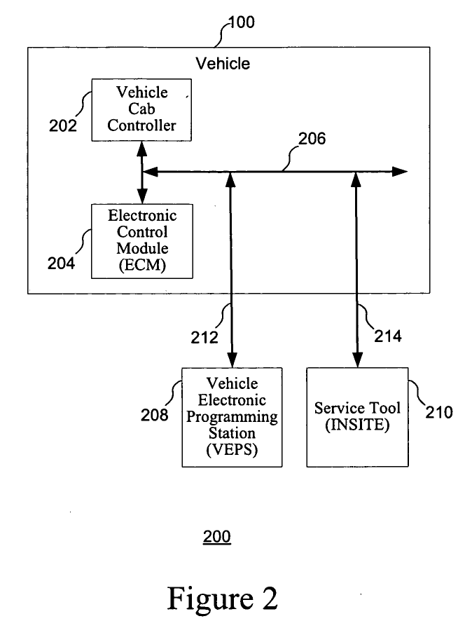

FIG. 1 is a block diagram of a vehicle 100 in accordance with one embodiment. As FIG. 1 shows, the vehicle 100 includes an engine 102 and a transmission system 104. FIG. 2 is a block diagram of a fan curve selection system 200 in accordance with another embodiment. As FIG. 2 shows, the fan curve selection system 200 includes a vehicle cab controller 202 and an engine electronic control module (ECM) 204, which communicate via a datalink backbone 206. In one embodiment, the ECM 204 and vehicle cab controller 202 operate with the transmission system to provide a powertrain system. The vehicle cab controller 202, ECM 204, and datalink backbone 206 are part of the vehicle 100. In a specific embodiment, the datalink backbone 206 is a J1939 datalink backbone. The fan curve selection system 200 also includes a vehicle electronic programming station (VEPS) 208 and a service tool 210, both of which couple to the datalink backbone via respective datalinks 212 and 214. In one embodiment, the VEPS 208 may be used to program the ECM 204 at the original equipment manufacturer (OEM) factory. In a specific embodiment, the service tool 210 may be used to transfer factory settings from a “failed” ECM to a new ECM. In a specific embodiment, the service tool 210 is a Cummins service tool (INSITE).

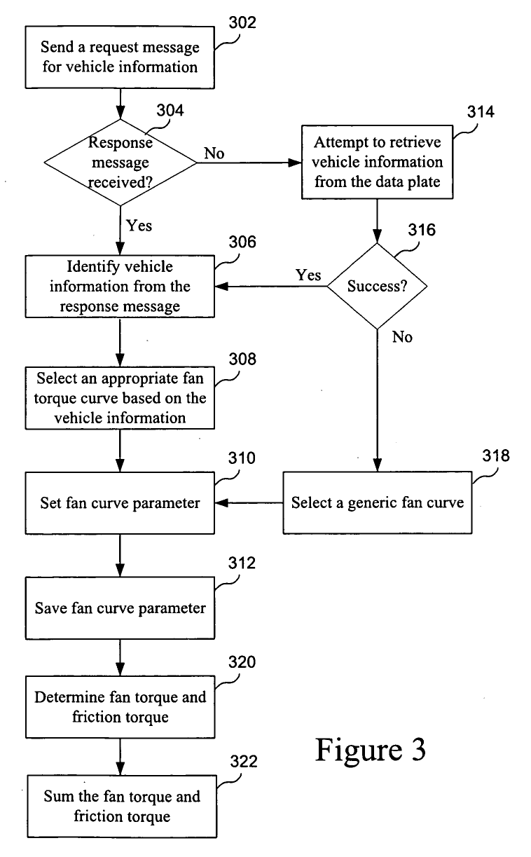

FIG. 3 is a flow chart showing a method for selecting a fan curve in accordance with one embodiment. Referring to both FIGS. 2 and 3 together, the process begins in step 302, when the ECM 204 requests vehicle information by sending a request message (e.g., component ID message) for vehicle information to the vehicle's cab controller 202, over the datalink backbone 206. In one embodiment, the vehicle identification message includes vehicle make and vehicle model information. In one embodiment, step 302 is performed at each engine key-on of the vehicle. As such, every time the engine key is turned on, a check is made as to the fan curve information. The ECM 204 is constantly observed so that the correct fan curve is determined, no matter what happens with the ECM 204. In the rare occurrence that the ECM 204 has gone bad in a particular truck, and the engine does not operate, there may be another truck that has a good ECM. Accordingly, the good ECM on the latter truck may be used to replace the bad in ECM on the former truck.

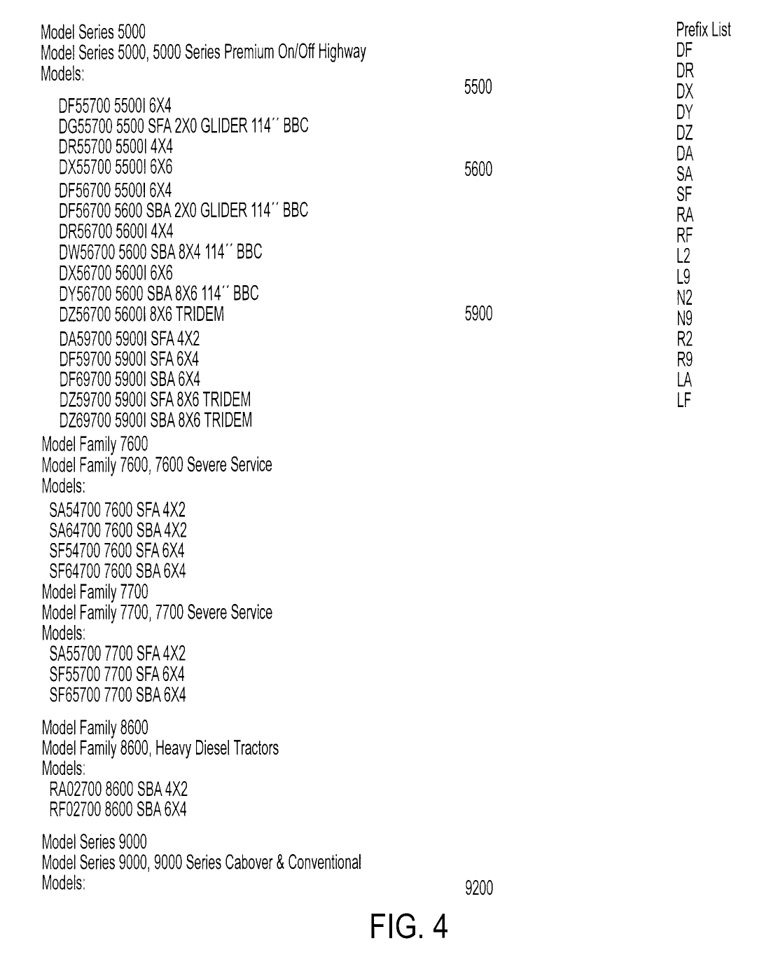

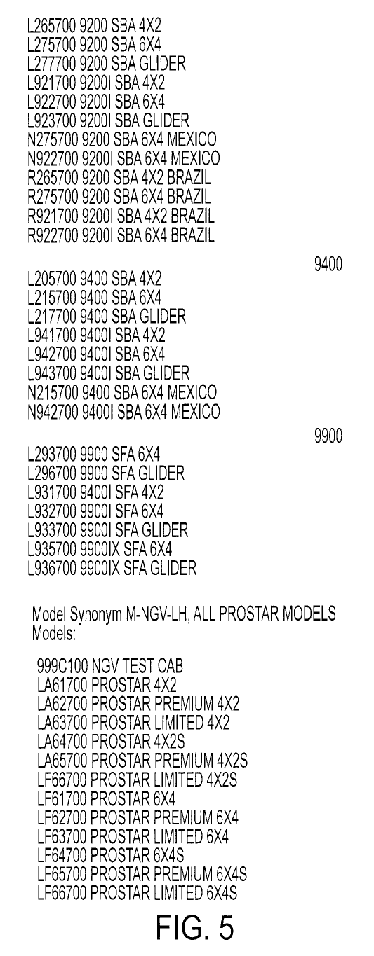

Next, in step 304, the ECM 204 determines if it has received a response message from the cab controller 202. If the ECM 204 receives a response message, in step 306, the ECM 204 identifies the vehicle information (e.g., vehicle make and model) from the response message. Next, in step 308, the ECM 204 selects an appropriate fan curve based on the vehicle information. In one embodiment, the ECM 204 initially stores fan curves for various makes and models. In one embodiment, a fan curve may indicate a fan make, fan model, drive ratio, number of blades, and fan diameter that is connected to the engine. FIG. 4 illustrates an example table showing fan curves for different engines in accordance with one embodiment. FIG. 5 illustrates an example table showing fan curves for different engines in accordance with another embodiment. FIGS. 4 and 5 show example vehicle makes and models that may be offered by one vehicle OEM. In embodiment, each model family has one fan option. For example, referring to FIG. 4, all 7700 model family vehicles have the same fan.

Referring again to FIG. 3, in step 310, the ECM 204 sets a fan curve parameter with an index number that corresponds to the selected fan curve. The fan curve parameter is also referred to as an “Active Fan Curve” parameter. Next, in step 312, the ECM 204 saves the fan curve parameter. In one embodiment, the ECM 204 saves the fan curve parameter permanently. In one embodiment, step 312 is performed at each engine key-off of the vehicle.

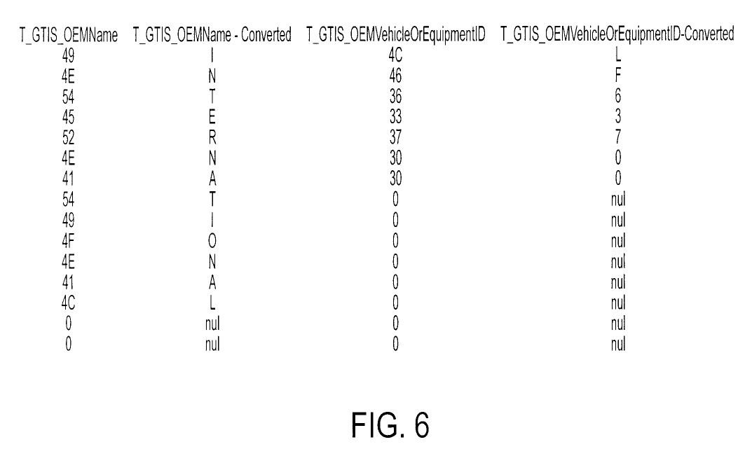

Referring again to step 304, if the ECM 204 does not receive a response message from the vehicle cab controller 202, in step 314, the ECM 204 attempts to retrieve the vehicle information (e.g., make and model) from a data plate. In one embodiment, a data plate is a portion of the EMC 204 that stores vehicle information such as vehicle make and model. When a given vehicle is built, the ECM includes a data plate, regardless of the manufacturer. FIG. 6 illustrates a table of information programmed into an engine data plate for a particular engine in accordance with one embodiment.

Referring again to FIG. 3, in step 316, the ECM 204 determines if it is successful in retrieving the vehicle information from the data plate. If so, in step 306, the ECM 204 selects an appropriate fan curve based on the vehicle information, and then sets and saves the fan curve parameter. If the vehicle information is not available from the data plate, in step 318, the ECM 204 selects a generic fan curve, and then sets and saves the fan curve parameter. In one embodiment, engines are shipped with the fan curve parameter set to the index value for the generic fan curve.

Next, in step 320, the ECM 204 determines the fan torque from the selected fan curve and determines the friction torque. In one embodiment, the friction torque is a parameter that indicates the amount of torque being consumed by parasitic losses or accessory loads. Next, in step 322, the ECM 204 sums the fan torque and friction torque. In conventional systems, the friction torque is not available for use by the transmission. For example, under a quasi steady-state no-load condition, the broadcasted value of actual engine torque will increase by some amount when the fan comes on. The amount of increase is directly proportional to the amount of fan load. If the engine does not increase the value of friction torque by the correct corresponding amount, the transmission will interpret the increase as a change in grade which may result in poor shift decisions. Embodiments of the present invention eliminate this problem by summing the fan torque with the friction torque to eliminate the torque error. The ECM 204 may then broadcast an accurate torque for the vehicle, as the proper torque curve is used to compensate for the fan.

In one embodiment, if the ECM 204 had previously selected a non-generic fan curve, and if there is no response to the ECM's current request for vehicle information, the ECM 204 may use the current value of fan curve parameter and set a fault indicating a loss of communication with the cab controller 202. In one embodiment, a provision may be provided to clear the fault in order to accommodate the case where an ECM is removed from the engine installed in one vehicle make and then installed on an engine in another vehicle of a different make and model. In one embodiment, a single fan curve may be scalable. In one embodiment, an in-service fan power estimation algorithm may be used.

According to the method and system disclosed herein, the present invention provides numerous benefits. For example, embodiments of the present invention provide accurate fan torque selection and compensation and provide an accurate broadcast of engine torque when the fan is on. Embodiments also allow the ECM to determine and apply the proper fan curve without human intervention, thereby eliminating the possibility of a fan curve being erroneously selected. Embodiments also improve engine and transmission performance. Embodiments also eliminate shift inhibits due to inaccurate broadcast torque. Embodiments also require no additional electronic tool support. Embodiments also reduce the amount of time, resources, and expense required to obtain transmission certification. Embodiments also eliminate or minimize the amount of fan torque compensation validation testing.

A method and system in accordance with the present invention involving fan curve information has been disclosed. The method includes engine electronic control module (ECM) sending a request message to a vehicle cab controller for vehicle information. If a response message is received, the ECM identifies the vehicle information from the response message and selects a fan curve based on the vehicle information. As a result, embodiments of the present invention provide accurate fan torque selection and compensation.

The present invention has been described in accordance with the embodiments shown. One of ordinary skill in the art will readily recognize that there could be variations to the embodiments, and that any variations would be within the spirit and scope of the present invention. For example, embodiments of the present invention may be implemented using hardware, software, a computer-readable medium containing program instructions, or a combination thereof. Software written according to the present invention or results of the present invention may be stored in some form of computer-readable medium such as memory, hard drive, CD-ROM, DVD, or other media for subsequent purposes such as being executed or processed by a processor, being displayed to a user, etc. Also, software written according to the present invention or results of the present invention may be transmitted in a signal over a network. In some embodiments, a computer-readable medium may include a computer-readable signal that may be transmitted over a network. Accordingly, many modifications may be made by one of ordinary skill in the art without departing from the spirit and scope of the appended claims.

What is claimed is:

1. A method for use in a vehicle, the method comprising:
providing a plurality of fan curves in a vehicle;
requesting vehicle information; and
selecting a fan curve from the plurality of fan curves based on the vehicle information.

2. The method of claim 1 further comprising:
sending a request message for vehicle information; and
identifying the vehicle information from the response message

3. The method of claim 1 further comprising:
setting a fan curve parameter with an index number that corresponds to the selected fan curve; and
saving the fan curve parameter.

4. The method of claim 1 further comprising:
setting a fan curve parameter with an index number that corresponds to the selected fan curve; and
saving the fan curve parameter, wherein the saving of the fan curve parameter is performed at each engine key-off of the vehicle.

5. The method of claim 1 further comprising:
if a response message is not received, attempting to retrieve the vehicle information from a data plate;
if the vehicle information is successfully retrieved from the data plate, selecting an appropriate fan curve based on the vehicle information; and
if the vehicle information is not available from the data plate, applying a generic fan curve.

6. The method of claim 1 further comprising:
determining a fan torque from the selected fan curve;
determining a friction torque; and
summing the fan torque and friction torque.

7. The method of claim 1 wherein the vehicle information comprises a vehicle make and model.

8. The method of claim 1 wherein the sending of the request message is performed at each engine key-on of the vehicle.

9. A transmission system comprising:
a vehicle cab controller operative to provide vehicle information; and
an electronic control module (ECM) operatively coupled to the vehicle cab controller, the ECM operable to:
provide a plurality of fan curves in a vehicle;
request vehicle information; and
select a fan curve from the plurality of fan curves based on the vehicle information.

10. The system of claim 9 wherein the ECM is further operable to:
set a fan curve parameter with an index number that corresponds to the selected fan curve; and
save the fan curve parameter.

11. The system of claim 9 wherein the ECM is further operable to:
set a fan curve parameter with an index number that corresponds to the selected fan curve; and
save the fan curve parameter, wherein the saving of the fan curve parameter is performed at each engine key-off of the vehicle.

12. The system of claim 9 wherein the ECM is further operable to:
if a response message is not received, attempt to retrieve the vehicle information from a data plate;
if the vehicle information is successfully retrieved from the data plate, select an appropriate fan curve based on the vehicle information; and
if the vehicle information is not available from the data plate, apply a generic fan curve.

13. The system of claim 9 wherein the ECM is further operable to:
determine a fan torque from the selected fan curve;
determine a friction torque; and
sum the fan torque and friction torque.

14. The system of claim 9 wherein the vehicle information comprises a vehicle make and model.

15. The system of claim 9 wherein the ECM is operable to send the request message at each engine key-on of the vehicle.

16. A vehicle comprising:
an engine; and
a transmission system coupled to the engine, the transmission system comprising:
a vehicle cab controller operative to provide vehicle information; and
an electronic control module (ECM) operatively coupled to the vehicle cab controller, the ECM operable to:
provide a plurality of fan curves in a vehicle;
request vehicle information; and
select a fan curve from the plurality of fan curves based on the vehicle information.

17. The vehicle of claim 16 wherein the ECM is further operable to:
set a fan curve parameter with an index number that corresponds to the selected fan curve; and
save the fan curve parameter.

18. The vehicle of claim 16 wherein the ECM is further operable to:
if a response message is not received, attempt to retrieve the vehicle information from a data plate;
if the vehicle information is successfully retrieved from the data plate, select an appropriate fan curve based on the vehicle information; and
if the vehicle information is not available from the data plate, apply a generic fan curve.

19. The vehicle of claim 16 wherein the ECM is further operable to:
determine a fan torque from the selected fan curve;
determine a friction torque; and
sum the fan torque and friction torque.

20. The vehicle of claim 16 wherein the vehicle information comprises a vehicle make and model.
